(19) United States
(12) Patent Application Publication
(10) Pub. No.: US 2011/0316992 A1
(43) Pub. Date: Dec. 29, 2011

(54) Image Playback System, Associated Apparatus and Method Thereof

(75) Inventors: Kun-Nan Cheng, Hsinchu Hsien (TW); Su-Chun Wang, Hsinchu Hsien (TW); Chih Wei Chen, Hsinchu Hsien (TW)

(73) Assignee: MSTAR SEMICONDUCTOR, INC., Hsinchu Hsien (TW)

(21) Appl. No.: 13/077,562

(22) Filed: Mar. 31, 2011

(30) Foreign Application Priority Data
Jun. 24, 2010 (TW) 099120697

(51) Int. Cl. H04N 13/04

(52) U.S. Cl. 348/56; 348/54; 348/58; 348/E13.036

(57) ABSTRACT

An image playback system displays three-dimensional (3D) content data via a pair of glasses together with a monitor to provide a multiplexing service to a user wearing different types of glasses via a single monitor. For a multiplexing service, the monitor interleaving displays frames of different content data to provide predetermined content data to the user while the glasses shelters other content data.

### CROSS REFERENCE TO RELATED PATENT APPLICATIONS

This patent application claims priority from Taiwan Patent Application No. 099120697, filed in the Taiwan Patent Office on Jun. 24, 2010, entitled “Image Playback System, Associated Apparatus and Method Thereof”, and incorporates the Taiwan patent application in its entirety by reference.

### TECHNICAL FIELD

The present disclosure relates to an image playback system, associated apparatus and method thereof, and more particularly to an image playback system, associated apparatus and method thereof, capable of implementing a multiplexing service of providing different content data to different users via a single monitor by deploying a capability of playing three-dimensional (3D) data of the image playback system.

### BACKGROUND OF THE PRESENT DISCLOSURE

In the modern information society, a large amount of various messages, information, news, knowledge, opinions, ideas, experiences and interactive contents are digitalized, which can be played to users by an image playback system.

A common, general image playback system, e.g., a television (TV), comprises a monitor for converting content data into frames. However, in various applications frames of different content data need to be provided to different users of a single monitor. For example when family members share a single monitor, different members wish to watch different channels; hence, content data of different channels needs to be presented to different users, respectively. Alternatively, when different members sharing a single monitor wish to play interactive, cooperative or competitive electronic games, different content data also needs to be provided to different users, respectively.

In response to the above applications and requirements, frames of different content data are displayed on a single monitor via a frame-division approach in the prior art. For example, a conventional TV divides the display area of its monitor into left and right parts (or top and bottom parts) via a picture by picture (PBP) technique to display frames of different content data. Similar techniques include picture in picture (PIP) and picture out picture (POP) techniques. The former technique divides a sub-area from the display area for displaying a set of content data while another set of content data is displayed in the remainder of the display area. The latter technique divides two different sub-areas in the overall display area for respectively displaying different content data.

However, the above conventional techniques still have numerous disadvantages. For example, each set of different content data cannot be completely displayed in the display area of the monitor in a full screen mode, e.g., frames of different perspectives in a tennis doubles game of an electronic game machine Wii can only be displayed respectively in divided display areas. In addition, having multiple sets of different content data displayed simultaneously on a screen also causes interference to each other, i.e., a user of a certain set of content data cannot focus on the data needed since other content data can also be seen on the screen. When users sharing a same monitor play a competitive electronic game, the foregoing disadvantages may cause mutual leakage of content data of competitors and thus spoil the fun of the games.

### SUMMARY OF THE PRESENT DISCLOSURE

In order to provide respective content data to different users via the same monitor, an image playback system provided by the present disclosure provides a multiplexing service by playing 3D content data, such that different users sharing a single monitor are respectively provided with different content data.

One object of the present disclosure is to provide an image playback system comprising a monitor, a first pair of glasses and a second pair of glasses. The monitor operating in a 3D mode displays 3D content data, or operating in a multiplexing mode provides a multiplexing service. When the monitor operates in the 3D mode, the monitor displays a left frame and a right frame of 3D content data. When the monitor operates in the multiplexing mode, the monitor displays a first frame of a first content data and a second frame of a second content data. When the monitor operates in the multiplexing mode, a user of the first content data wears a first glasses of which a left lens and a right lens shelter the second frame displayed by the monitor, and the first frame displayed by the monitor is transmitted through at least one of the left and right lenses, such that the user of the first glasses may view the first content data while excluding the second content data. Likewise, a user of the second content wears the second glasses of which both left and right lenses shelter the first frame displayed by the monitor, and the second frame displayed by the monitor is transmitted through at least one of the left and right lenses of the second glasses.

A sequential 3D content data image playback system according to the present disclosure comprises a monitor that sequentially interleavingly displays a first frame and a second frame, with a first pair of glasses and a second pair of glasses being active shutter glasses. In the multiplexing mode, left and right lenses of the first glasses synchronously shelter the second frame when the monitor displays the second frame. Likewise, left and right lenses of the second glasses synchronously shelter the first frame when the monitor displays the first frame. The present disclosure may also be extended to N different content data respectively displayed cooperating with N glasses. When a user of one pair of glasses provides content data, only a frame corresponding to the content data is transmitted through the glasses while other frames corresponding to other content data are sheltered.

A sequential 3D content data image playback system based on polarization according to the present disclosure comprises a monitor for respectively performing a left display and a right display with different first polarization and second polarization. When the image playback system provides the multiplexing service, lights polarized by the first polarization transmit through the left and right lenses of the first glasses while lights polarized by the second polarization are sheltered; and lights polarized by the second polarization transmit through the left and right lenses of the second glasses while lights polarized by the first polarization are sheltered.

In order to provide the multiplexing service, the first glasses and the second glasses respectively comprise a first identification code and a second identification code. The monitor transmits the first identification code and the second identification code via a predetermined program to the first glasses and the second glasses, respectively. For example, the first glasses and the second glasses respectively comprise a first switch and a second switch. When the monitor broadcasts an identification code, in the event that the first switch is pressed, the first glasses records the identification code as the first identification code of the first glasses. At this point, when the second switch is not pressed, the second glasses do not record the broadcast identification code as the second identification code. That is, users of the first glasses and the second glasses selectively record the broadcast identification code in the first glasses and the second glasses by selectively pressing the first switch and the second switch. In another embodiment, the first glasses and the second glasses respectively comprise a first switch and a second switch for defining identification codes. By adjusting the first switch and the second switch, the first glasses obtain a first identification code and the second glasses obtain a second identification code.

Another object of the present disclosure is to provide glasses cooperating with a monitor. The glasses, operating in a 3D mode and a multiplexing mode, comprise a left lens and a right lens. When the glasses operate in the 3D mode, a left frame displayed on the monitor is transmitted though the left lens while a right frame displayed on the monitor is sheltered, and the right frame displayed on the monitor transmits through the right lens while the left frame displayed on the monitor is sheltered. When the glasses operates in the multiplexing mode, the monitor displays the first frame of the first content data and the second frame of the second content data respectively by displaying the left frame and the right frame. The first frame displayed on the monitor transmits through at least one of the left lens and the right lens, and the second frame is sheltered by both of the left lens and the right lens. A switch may be configured in the glasses for planning an identification code to the glass. Alternatively, when the switch is pressed, the identification code broadcast by the monitor is recorded as an identification code of the glasses, or an identification code selected by the user is received.

Yet another object of the present disclosure is to provide a method applied to an image playback system so as to provide a multiplexing service by deploying a capability of playing 3D content data of the image playback system. The method comprises arranging a first frame of first content data as a left frame and arranging a second frame of second content data as a right frame when the multiplexing service is provided; and sheltering by left and right lenses of the glasses a right frame displayed on a monitor, and sheltering by left and right lenses of another glasses the left frame displayed on the monitor.

Still another object of the present disclosure is to provide an image playback system comprising a monitor and a plurality of glasses. The monitor displays a plurality of pixels. When the monitor displays a certain predetermined frame, the predetermined frame is transmitted through one or more glasses (e.g., both left and right lenses are transmitted through or only one of the left and right lenses is transmitted through), and the predetermined frame is sheltered by other glasses (e.g., both left and right lenses are sheltered). The frames are associated with a plurality of content data, i.e., the monitor displays different content data on different frames to provide a multiplexing service to a plurality of users of a plurality of glasses. Preferably, the monitor sequentially displays the frames in sequence, e.g., the monitor associated with a pair of shutter glasses interleaving displays frames of different content data. Alternatively, the monitor simultaneously displays frames of different content data within an intra frame, e.g., the frames of different content data are simultaneously displayed with different polarization lights, respectively.

Still another object of the present disclosure is to provide a method for providing a multiplexing service. The method comprising integrating a plurality of content data to a same stream, with each content data comprising a plurality of pixels, the stream comprising a plurality of intra frames respectively associated with the frames; transmitting the stream to an image playback system; and playing the intra frames of the stream by the image playback system to display frames of the content data. One intra frame may be associated with frames of different content data, or one intra frame can be associated with a frame of content data. The image playback system comprises a monitor and a plurality of glasses. When the image playback system plays the stream, the intra frames are displayed on the monitor, and selectively transmitted through and sheltered by the glasses.

The advantages and spirit related to the present disclosure can be further understood via the following detailed description and drawings.

### BRIEF DESCRIPTION OF THE DRAWINGS

FIG. 1 is a schematic diagram of a technique principle of an image playback system according to an embodiment of the present disclosure.

FIG. 2 is a block diagram of circuits of an image playback system according to an embodiment of the present disclosure.

FIG. 3 is a schematic diagram of the image playback system in FIG. 2 implementing a multiplexing mode by deploying a 3D content data displaying capability thereof according to an embodiment of the present disclosure.

FIG. 4 to FIG. 10 are schematic diagrams of integration of content data in a multiplexing mode according to an embodiment of the present disclosure.

FIG. 11 is a schematic diagram of an image playback system according to another embodiment of the present disclosure.

FIG. 12 to FIG. 14 are schematic diagrams of the image playback system in FIG. 11 providing a multiplexing mode according to embodiments of the present disclosure.

FIG. 15 is a flowchart of a multiplexing display service according to an embodiment of the present disclosure.

### DETAILED DESCRIPTION OF THE PREFERRED EMBODIMENT

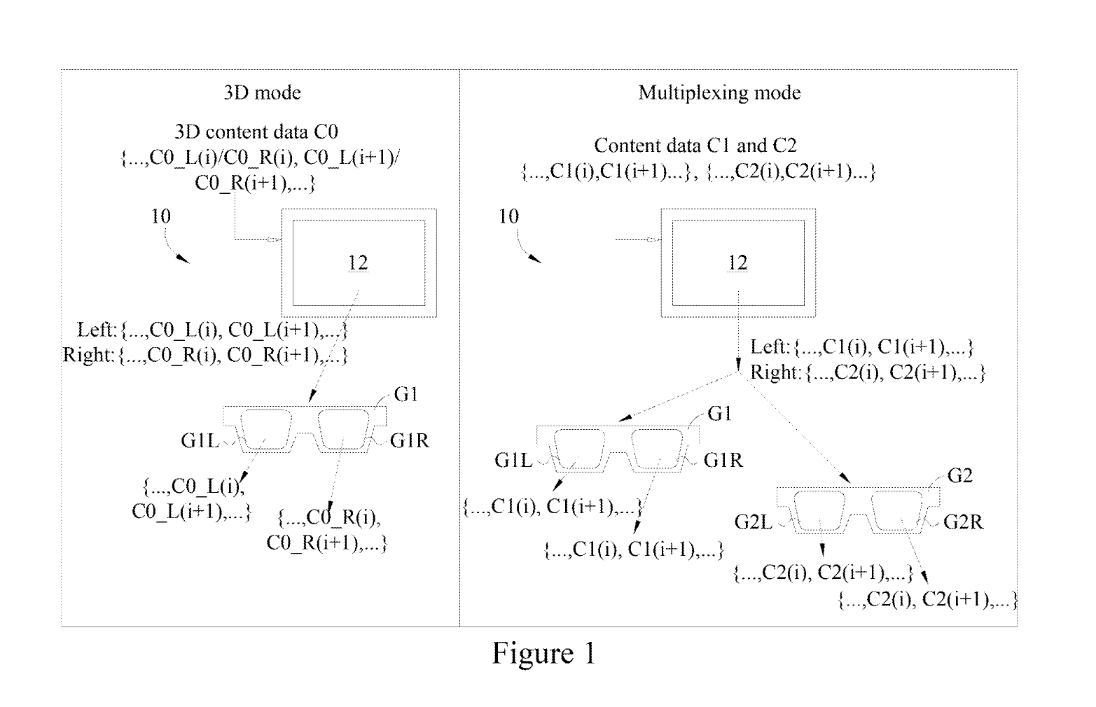

FIG. 1 is a schematic diagram of a principle of an image playback system 10 according to an embodiment of the present disclosure. The image playback system 10 comprises a monitor 12 and appurtenant glasses, which are represented by G1 and G2 in FIG. 1. The glasses G1 comprise a left lens G1L and a right lens G1R, and the glasses G2 comprise a left lens G2L and a right lens G2R. The image playback system 10 is capable of displaying 3D content data C0. For example, the content data C0 can be a data stream comprising data C0_L(i), C0_R(i), C0_L(i+1) and C0_R(i+1). The data C0_L(i) and C0_L(i+1) correspond to left frames (i.e., intra frames) of the 3D content data, which are provided to the left eye of a user, and the data C0_R(i) and C0_R(i+1) correspond to right frames of the 3D content data, which are provided to the right eye of the user. The monitor 12 operates in a 3D mode to display the 3D content data C0. More specifically, the monitor 12 performs a left display to display the data C0_L(i) and C0_L(i+1) as the corresponding left frames, and performs a right display to display the data C0_R(i) and C0_R(i+1) as the corresponding right frames. Since the left frames and the right frames are displayed in a mixed way, the left frames and the right frames are transmitted respectively to the left eye and the right eye of the user with the glasses (i.e., a person wearing the glasses). Take the glasses G1 as an example, the left frames corresponding to the data C0_L(i) and C0_L(i+1) are transmitted through the left lens G1L of the glasses G1 to the left eye of the user, and the right frames corresponding to the data C0_R(i) and C0_R(i+1) are sheltered. Likewise, the right frames corresponding to the data C0_R(i) and C0_R(i+1) are transmitted through a right lens G1R to the right eye of the user. Through the left lens G1L and the right lens G1R, left and right eyes of the user may perceive a parallax to simulate a 3D image.

According to the present disclosure, a multiplexing mode is established by deploying a capability of displaying 3D content data by the image playback system 10 to provide a multiplexing display service, such that a single monitor 12 separately provides different content data to different users, e.g., content data C1 and C2. The content data C1 comprises the data C1(i), C1(i+1), etc., which correspond to different frames of the content data C1 (e.g., intra frames). Likewise, the content data C2 comprises the data C2(i), C2(i+1), etc., which correspond to different frames of the content data C2. When the image playback system 10 operates in the multiplexing mode, the frames corresponding to the data C1(i) and C1(i+1) are displayed according to an approach for displaying the left frames in the 3D mode, and the frames corresponding to the data C2(i) and C2(i+1) are displayed according to an approach for displaying the right frames in the 3D mode.

Associated with operations of the monitor 12, in the multiplexing mode, the data C2(i) and C2(i+1) of the right frames are sheltered by the left lens G1L and the right lens G1R of the glasses G1, while only the data C1(i) and C1(i+1) of the left frame can be transmitted through. The data C1(i) and C1(i+1) of the left frames are sheltered by the left lens GL and the right lens G1R of the glasses G2, while only the data C2(i) and C2(i+1) of the right frames can be transmitted through. Therefore, for a user wearing the glasses G1, the monitor 12 displays the content data C1 in a full screen mode without interference by the content data G2. Likewise, for a user viewing the content data C2 wearing the glasses G2, the content data C2 is also displayed in a full screen mode without interference of frames of the content data C1, so as to achieve and object of providing the multiplexing display service via a single monitor.

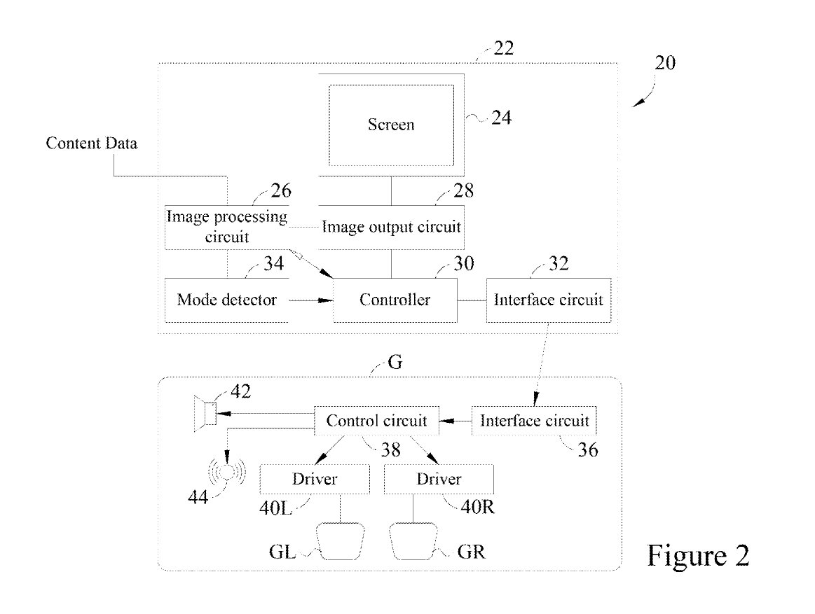

FIG. 2 is a schematic diagram of an image playback system 20 according to an embodiment of the present disclosure. The image playback system 20 comprises a monitor 22 and a plurality of associated glasses; in FIG. 2, a glasses G is employed as a representative of the associated glasses. The monitor 22 comprises a screen 24, an image processing circuit 26, an image output circuit 28, a controller 30, an interface circuit 32, and a mode detector 34. The glasses G further comprises another interface circuit 36, a control circuit 38, two drivers 40R and 40L, and a left lens GL and a right lens GR. The glasses G also selectively comprises a speaker (or earphone) 42 and/or a vibrator 44. The controller 30 of the monitor 22 dominates operations of the monitor 22, and the mode detector 34 is capable of analyzing content data and/or receiving instructions from users, such that the controller 30 determines how to display the content data accordingly and controls an operating mode of the monitor 22/the image playback system 20. The image processing circuit 26 performs corresponding image processing on the content data, such as decoding, decompressing, scaling and/or de-interlacing. The screen 24 can be a liquid crystal display (LCD) panel. Under control of the controller 30, the image output circuit 28 drives the screen 24 according to image processing results of the image processing circuit 26 to convert the content data to frames for watch by users.

In this embodiment, the pair of glasses G is an active shutter glasses. For example, the left lens GL and the right lens GR are filled with liquid crystal, and status thereof is controlled by electronic signals provided by the drivers 40L and 40R. When the status of liquid crystal of the left lens GL and the right lens GR is changed, the transparency of left lens GL and that of the right lens GR are respectively changed, allowing frames displayed on the monitor 22 to be transmitted through or sheltered, respectively. The interface circuit 32 of the monitor 22 and the interface circuit 36 of the glasses G establish a mutual communication channel between the monitor 22 and the glasses G, for coordinating synchronized operations of the glasses G and monitor 22. For example, the interface circuits 32 and 36 may establish a remote mutual communication channel by radio signals (e.g., radio-frequency (RF) signals or Bluetooth) or infrared signals. The control circuit 38 of the glasses G dominates operations of the glasses G. For example, the control circuit 38 controls the drivers 40L and 40R according to a signal received by the interface circuit 36, and the driver 40L is controlled to drive the left lens GL, adjusting the left lens GL to allow the frames to be transmitted through or sheltered. Likewise, selection of allowing the frames of the right lens GR to be transmitted through or sheltered is controlled by the driver 40R.

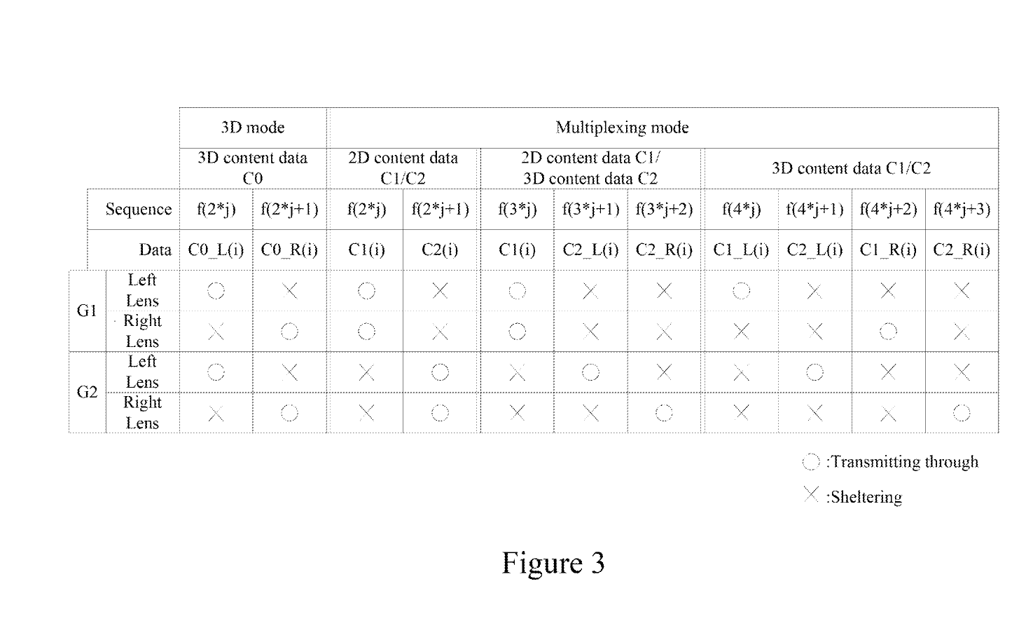

FIG. 3 is a schematic diagram of the image playback system 20 with a 3D content data displaying capability implementing a multiplexing service according to an embodiment of the present disclosure. In FIG. 3, the monitor 22 associated with two glasses G1 and G2 is taken as an example to describe the techniques of the present disclosure, wherein structures and operating principles of the glasses G1 and G2 are identical to the glasses G in FIG. 2.

When the image playback system 20 operating in the 3D mode displays data C0_L(i), C0_R(i), C0_(i+1) and C0_R(i+1) of 3D content data C0, the monitor 22 displays the data as frames f(2*j), f(2*j+1), f(2*j+2) and f(2*j+3) in sequence. That is, the frames f(2*j) and f(2*j+2) are left frames of the 3D content data C0, and the frames f(2*j+1) and f(2*j+3) are right frames of the 3D content data C0.

Under synchronization of the interface circuits 32 and 36, the left frame f(2*j) is synchronously transmitted through the left lenses of the glasses G1 and G2 when the monitor 22 displays the frame f(2*j), such that the left frame f(2*j) is transmitted to the left eye of users (i.e. users wear the glasses G1 or G2), while the left frame f(2*j) is synchronously sheltered by the right lenses. When monitor 22 displays the frame f(2*j+1), the right frame f(2*j+1) is synchronously transmitted through the right lenses of the glasses G1 and G2, and is synchronously sheltered by the left lenses, such that the frame f(2*j+1) is only transmitted to the right eye of the users. In other words, when the image playback system 20 displays the 3D content data, the monitor 22 interleaving displays the left frames and the right frames in sequence, and both of the left lenses/right lenses of the glasses G1 and G2 synchronously alternate between “transmitting through/sheltering” and “sheltering/transmitting through” status, such that the users wearing the glasses G1 and G2 can simultaneously view the 3D content data C0. In the 3D mode, when the monitor 22 displays a frame to the users, the left lens and the right lens of the same glasses are complementary, i.e., when one lens transmits through the frame, the other shelters the frame. None of the frames can be transmitted through or sheltered by both of the left lens and the right lens of the same glasses.

In this embodiment, when the image playback system 20 operates in the multiplexing mode, different multiplexing services are provided as shown in FIG. 3. The image playback system 20 separately plays two-dimensional (2D) content data C1 and C2 to the users wearing the glasses G1 and G2, respectively. When the multiplexing service is provided, data C1(i) and C1(i+1) of the 2D content data C1 respectively correspond to frames f(2*j) and f(2*j+2) to be displayed on the monitor 22, i.e., the data C1(i) and C1(i+1) are displayed as left frames. Data C2(i) and C2(i+1) of the 2D content data C2 respectively correspond to frames f(2*j+1) and f(2*j+3) to be displayed on the monitor 22, i.e., the data C2(i) and C2(i+1) are displayed as right frames. More specifically, when the monitor 22 displays the frame f(2*j), the frame f(2*j) is synchronously transmitted through the left lens and the right lens of the glasses G1, and is synchronously sheltered by the left lens and right lens of the glasses G2. On the other hand, when the monitor displays the frame f(2*j+1), the frame f(2*j+1) is synchronously sheltered by the left lens and the right lens of the glasses G1, and is synchronously transmitted through the left lens and the right lens of the glasses G2.

As the monitor 22 displays the frames f(2*j), f(2*j+1), f(2*j+2) and f(2*j+3) in sequence, the user wearing the glasses G1 view the frames corresponding to the data C1(i) and C1(i+1) in sequence with both eyes when the frames f(2*j) and f(2*j+2) are displayed, so as to display the content data C1 to the user wearing the glasses G1. Since the left lens and the right lens of the glasses G1 simultaneously shelter the frames f(2*j+1) and f(2*j+3) corresponding to the data C2(i) and C2(i+1), the user of the glasses G1 cannot view the content data C2, i.e., the user of the glasses G1 is not interfered by the content data C2. Likewise, the user wearing the glasses G2 view the frames corresponding to the data C1(i) and C1(i+1) in sequence when the frames f(2*j+1) and f(2*j+3) are displayed, so as to play the content data C2 to the user wearing the glasses G2, and thereby excluding the content data C1. In addition, since the data C1(j), C1(i+1), C2(i) and C2(i+1) of the content data C1 and C2 are respectively completely displayed as the frames f(2*j), f(2*j+1), f(2*j+2) and f(2*j+3), the users of the glasses G1 and G2 can respectively view complete content data C1 and C2.

In another embodiment, according to the multiplexing service, 2D data and 3D data are mixedly provided to different users. For example, when the 2D data and the 3D data C2 are provided to the users of the glasses G1 and G2, respectively, the monitor 22 correspondingly displays the data C1(i) and C1(i+1) of the 2D content data C1 as frames f(3*j) and f(3*j+3). In the 3D content data C2, the data C2_L(i) and C2_L(i+1) corresponding to left eyes are displayed as frames f(3*j+1) and f(3*j+4), and the data C2_R(i) and C2_R(i+1) corresponding to right eyes are displayed as frames f(3*j+2) and f(3*j+5). When the monitor 22 displays the frame f(3*j), the frame f(3*j) is synchronously transmitted through the left lens and the right lens of the glasses G1, and is synchronously sheltered by the left lens and the right lens of the glasses G2. When the monitor 22 displays the frame f(3*j+1), the frame f(3*j+1) is synchronously sheltered by the right lens of the glasses G2, and the left lens and the right lens of the glasses G1, while the frame f(3*j+1) is transmitted through the left lens of the glasses G2. Likewise, when the monitor 22 displays the frame f(3*j+2), the frame f(3*j+2) is synchronously sheltered by the left lens of the glasses G2, and the left lens and the right lens of the glasses G1, while the frame f(3*j+2) is transmitted through the right lens of the glasses G2.

In other words, as the monitor 22 in sequence displays the frames f(3*j) to f(3*j+5), the user of the glasses G1 view the frames f(3*j) and f(3*j+3) corresponding to the data C1(i) and C1(i+1) in sequence with both eyes, i.e., the user of the glasses G1 views the content data C1 in a 2D approach. The user of the glasses G2 views the frames f(3*j+1), f(3*j+2), f(3*j+4) and f(3*j+5) corresponding to C2_L(i), C2_R(i), C2_L(i+1) and C2_R(i+1) in a sequence of left eye, right eye, left eye and right eye to view the 3D content data C2.

In another embodiment, the 3D content data C1 and C2 are respectively played to the user of glasses G1 and G2. For the content data C1, the data C1_L(i) and C1_L(i+1) corresponding to a left eye are displayed as frames f(4*j) and f(4*j+4), and the data C1_R(i) and C1_R(i+1) corresponding to a right eye are displayed as frames f(4*j+2) and f(4*j+6). Likewise, for the content data C2, the data C2_L(i) and C2_L(i+1) corresponding to a left eye are displayed as frames f(4*j+1) and f(4*j+5), and the data C2_R(i) and C2_R(i+1) corresponding to a left eye are displayed as frames f(4*j+3) and f(4*j+7). When the monitor 22 displays the frames f(4*j), f(4*j+1), f(4*j+2) and f(4*j+3) in sequence, the frames are transmitted through the left lens of the glasses G1, the left lens of the glasses G2, the right lens of the glasses G1 and the right lens of the glasses G2 in sequence. Under synchronous operations of the monitor 22 and the glasses, the user of the glasses G1 in sequence views frames f(4*j), f(4*j+2), f(4*j+4) and f(4*j+6) corresponding to the data C1_L(i), C1_R(i), C1_L(i+1) and C1_R(i+1), respectively, in a sequence of left eye, right eye, left eye and right eye to view the 3D content data C1. Likewise, the frames f(4*j+1), f(4*j+3), f(4*j+5) and f(4*j+7) corresponding to the data C2_L(i), C2_R(i), C2_L(i+1) and C2_R(i+1), respectively, are displayed to the user of the glasses G2 in a sequence of left eye, right eye, left eye and right eye to play the 3D content data C2 to the user of the glasses G2.

Please note that the content data C1 and C2 in FIG. 3 are merely an exemplary example for illustrating the multiplexing service of the present disclosure. Other embodiments of the present disclosure can provide the multiplexing service of a plurality of content data (i.e., more than two), rather than only two content data. For example, data C1(i), C2(i) and C3(i) of three 2D content data C1, C2 and C3 are respectively displayed as f(3*j), f(3*j+1) and f(3*j+2), which are only transmitted through both left lenses and right lenses of three glasses G1, G2 and G3 (not shown), respectively, while being sheltered at other times, so as to play the content data C1, C2 and C3 to the users of the three glasses G1, G2 and G3.

More specifically, when different glasses are operating at the same time, different glasses can be formed as a group to view the same content data. As an extension of the embodiment in FIG. 3, in the multiplexing mode, when transmitting through/sheltering sequence of the glasses G3 is identical to that of the glasses G1, the user of the glasses G3 may view the same content data C1 as the user of the glasses G1.

As for implementations of the above embodiments, transmitting through/sheltering status of glasses may be controlled via different techniques. In an embodiment, different identification codes are allocated to each glasses of the image playback system 20. When the controller 30 of the monitor 22, shown in FIG. 2, coordinates operations of the glasses, a glass control instruction can be transmitted by the interface circuit 32 for instructing the glasses bearing the identification codes corresponding to the glass control instruction, so as to respectively instruct the glasses to perform operations of transmitting through/sheltering. Upon receiving the instruction and the identification code, each of the glasses performs matching for the received identification code to an allocated identification code. When the received identification code matches with the predetermined identification code, the glasses execute the instruction; otherwise, when the received identification code does not match with the allocated identification code, meaning that the instruction is aiming at other glasses, the instruction is then omitted by the glasses. For example, when two glasses G1 and G2 are applied to multiplexing playing 2D content data C1 and C2, the controller 30 of the monitor 22 transmits a “left lens and right lens transmitting through” instruction with the identification code allocated to the glasses G1 and a “left lens and right lens sheltering” instruction with the identification code allocated to the glasses G2 when the frame f(2*j) is displayed, such that a user of the glasses G1 view the frame f(2*j) corresponding to the data C1(i) with both eyes.

Furthermore, various approaches can be applied for providing different identification codes to different glasses. For example, the control circuit 38 of the glasses G has a unique built-in identification code in manufacture (e.g., a group of serial numbers is burned into a read only memory (ROM) (not shown) of the control circuit 38). The control circuit 38 transmits the identification code via the interface circuit 36, such that the monitor 22 obtains the identification code of the glasses G to involve (identify) the glasses G as a member of the image playback system 20. Alternatively, the controller 30 actively allocates an identification code to each of the glasses with a predetermined procedure. For example, a setting button (e.g., a switch) is disposed on each of the glasses. When the image playback system 20 provides the multiplexing service, the user of the content data C1 is prompted by images or audios (from the screen 24) to continuously press the setting button, and thereby the identification code starts to be broadcast simultaneously. Upon receiving the broadcast identification code, a glasses with pressed setting button records the received identification code as its identification code, while a glasses with setting button un-pressed omits the received identification code. After that, the monitor 22 prompts the user of the content data C2 to press a setting button (e.g., a switch) of the glasses, and broadcasts another identification code. Accordingly, each of the glasses is allocated with an identification code for providing different content data according to user requirements.

Alternatively, a user-controlled interface can be configured in each of the glasses, e.g., a dip switch or a jumper switch, for allowing a user to define an identification code for the glasses. For example, when the image playback system 20 starts providing the multiplexing service, the monitor 22 prompts the user of the content data C1 to set a dip switch of the glasses thereof to be 1, and prompts the user of the content data C2 to set a dip switch of the glasses thereof to be 2. Accordingly, an identification registration between the monitor 22 and each of the glasses can be achieved for implementing the multiplexing service.

On the other hand, according to the present disclosure, the multiplexing service can even be implemented without the identification code. For example, the monitor 22 marks each frame as a left frame or a right frame in the broadcasting of the interface circuit 32 when displaying the frame, rather than transmitting a specific instruction to a specific pair of glasses. A user-controlled interface switch is disposed on each of the glasses, allowing the user to determine whether the glasses transmits through or shelters the left frame and the right frame. For example, when the image playback system 20 multiplexing plays the two 2D content data C1 and C2, the user of the glasses G1 defines both of the left lens and the right lens of the glasses G1 to simultaneously transmit through a left frame (e.g., the frame f(2*j)), and to simultaneously shelter a right frame (e.g., a frame f(2*j+1)) with the interface switch. The user of the glasses G2 defines both of the left lens and the right lens of the glasses G2 to simultaneously shelter a left frame (e.g., the frame f(2*j)), and to simultaneously transmit through a right frame (e.g., a frame f(2*j+1)) with the interface switch.

In the multiplexing mode, besides frames of different content data, audios of different content data are also provided to different users. As shown in FIG. 2, a speaker 42 configured in the glasses G can be a single-channel or multi-channel earphone. According to the present disclosure, the interface circuits 32 and 36 between the monitor 22 and the glasses G are applied to transmit audios of different content data to corresponding glasses. The speakers thereof convert the audios to audio waves, so as to play the audios to the users. More specifically, when the image playback system 20 respectively provides frames corresponding to the content data C1 and C2 to the users of the glasses G1 and G2, the audios corresponding to the content data C1 and C2 are also synchronously transmitted to the glasses G1 and G2, respectively; thus, the speakers thereof are capable of playing the audios of the content data C1 and C2 to the users, respectively. Accordingly, the users can not only view the content data but also hear the audios corresponding to the content data.

Likewise, in other embodiments, the content data further comprise other types of sensory data, and an actuator is configured in each of the glasses to convert the sensory data to sensory stimulations sensed by the user. For example, a vibrator 44 is configured in the glasses G in FIG. 2 to convert the vibration data of the content data to real vibration waves, such that the user may sense corresponding vibrations. Similar to the multiplexing service of the audios, various vibration data/sensory data of different multiplexing content data are played to different users of the glasses. In addition to transmit the above audios/vibration data/sensory data via the interfaces 32/36, other types of interface circuits designated for transmitting audios/vibration data/sensory data may be added between the monitor 22 and the glasses G.

In the embodiment shown in FIG. 2, the image processing circuit 26 receives a content data stream from an external signal source of the monitor 22, or from a built-in signal source of the monitor 22. The monitor 22 can be coupled to the external signal source via various types of video receiving terminals or signal connectors, e.g., an audible-visual (AV) terminal, a high definition multi-media interface (HDMI) terminal, a digital video interface (DVI) terminal, a video graphic array (VGA) terminal, a DisplayPort terminal, and/or a universal serial bus (USB), IEEE1394, Firewire or external serial advanced technology attachment interface (eSATA), or signal connector, etc., is connected to an external apparatus, such as a digital versatile disc (DVD) player/recorder, a blu-ray disc player/recorder, a hard disc/memory card player/recorder, a set-top box, a handheld apparatus having a video function (e.g., a mobile phone, a personal digital assistant (PDA) or a digital camera/video camera), a game console and/or a computer. In addition, the monitor 22 comprises a plurality of built-in tuners for resolving programs of a plurality of channels from TV signals provided by cable or wireless TV stations as signal sources. The monitor 22 may also comprise a built-in reader for reading a stream of signal sources from a memory card, or comprises a built-in non-volatile storage apparatus, e.g., a built-in hard disc, as one of signal sources. For example, the monitor 22 comprises a wireless network communication module or a wireless signal receiver (e.g., a communication module conforming to a mobile phone communication specification, a receiver conforming to a WiFi signal specification, etc.) to receive wireless signals as signal sources.

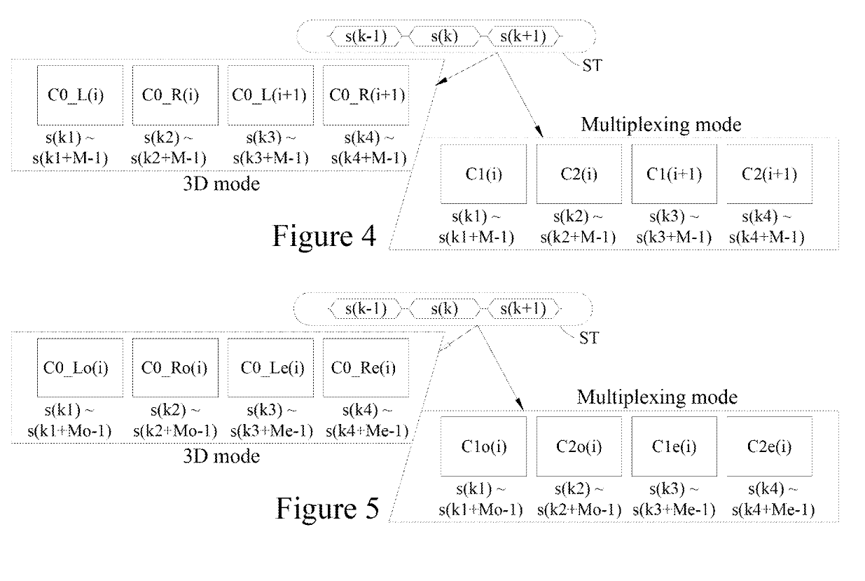

As for the implementation of the multiplexing mode, deploying the characteristic of the format of 3D content data, a plurality of content data in the multiplexing mode can be integrated to a single stream so as to provide the multiplexing service by deploying the 3D playing capability of the image playback system 20. FIG. 4 is a schematic diagram of integration of a plurality of content data according to an embodiment of the present disclosure. A signal stream received by the image processing circuit 26 is represented as a signal ST, within which scan lines s(k−1), s(k) to s(k+1) are regarded as units for carrying content data. Each frames corresponding to the content data can be derived by combining each of the pixel data recorded by each of the scan lines. Timing of the signal ST corresponds to a periodical vertical synchronous signal (not shown). Each cycle of the vertical synchronous signal corresponds to an intra frame, each corresponding to a plurality of the scan lines. In the embodiment of FIG. 4, the signal ST carries the 3D content data C0 in the 3D mode in a frame interleave form. As to the 3D data C0, the data C0_L(i) and C0_R(i) respectively correspond to a left frame and a right frame, so as to form a 3D image, and the data C0_L(i+1) and C0_R(i+1) respectively correspond to a left frame and a right frame of the next 3D image. In the embodiment of FIG. 4, the data C0_L(i) corresponding to the left frame (i.e., the left intra frame) is recorded in the scan lines S(k1) to s(k1+M−1) of the signal ST, and the data C0_R(i) corresponding to the right frame of the same 3D image is recorded in subsequent scan lines s(k2) to s(k2+M−1) of the signal ST. The data C0_L(i+1) and C0_R(i+1) corresponding to the left frame and right frame of the next 3D image are respectively recorded in sequence in scan lines s(k3) to s(k3+M−1) and s(k4) to s(k4+M−1) of the signal ST, wherein k2 is larger than or equal to (k1+M), k3 is larger than or equal to (k2+M), k4 is larger than or equal to (k3+M), and the like. In this embodiment, M scan lines correspond to a same vertical synchronous signal cycle, i.e., the scan lines s(k1) to s(k1+M−1) correspond to a vertical synchronous signal, and the scan lines s(k2) to s(k2+M−1) correspond to another vertical synchronous signal, and the like.

In the multiplexing mode, different content data C1 and C2 are integrated in a single signal ST. For example, the data C1(i) corresponding to a certain frame (i.e., an intra frame) of the content data C1 can be recorded in the scan lines s(k1) to s(k1+M−1), and the data C1(i+1) corresponding to the next frame of the content data C1 is recorded in the scan lines s(k3) to s(k3+M−1). In other words, in the multiplexing mode, each frame of the content data C1 represent each left frame of the 3D data C0 in the 3D mode. Likewise, the data C2(i) and C2(i+1) corresponding to two adjacent frames (e.g., intra frames) of the content data C2 are respectively recorded in the scan lines s(k2) to s(k2+M−1) and scan lines s(k4) to s(k4+M−1), which represent right frames of the 3D data C0. Accordingly, the plurality of content data in the multiplexing mode can be integrated in a single signal stream, which can be played by deploying the 3D playing capability of the image playback system 20. Associated with operations of glasses, the plurality of content data can be multiplexed and provided to different users.

FIG. 5 is a schematic diagram of integration of a plurality of content data in a multiplexing mode according to another embodiment of the present disclosure. As to the 3D content data C0 in the 3D mode, data C0_Lo(i) and C0_Le(i) respectively corresponds to an interleaving odd field and an even field of a left frame, and data C0_Ro(i) and C0_Re(i) respectively corresponds to an odd field and an even field of a right frame. In the signal ST, data C0_Lo(i), C0_Le(i), C0_Ro(i) and C0_Re(i) are recorded in sequence in scan lines s(k1) to s(k1+Mo−1), s(k2) to s(k2+Mo−1), s(k3) to s(k3+Me−1) and s(k4) to s(k4+Me−1), wherein k2 is larger than or equal to (k1+Mo), k3 is larger than or equal to (k2+Mo), k4 is larger than or equal to (k3+Me), and the like; Moreover, Mo can either be identical to or different from Me. In this embodiment, the scan lines s(k1) to s(k1+Mo−1), s(k2) to s(k2+Mo−1), s(k3) to s(k3+Me−1) and s(k4) to s(k4+Me−1) can be arranged to be corresponding to two vertical synchronous signal cycles.

In the embodiment of FIG. 5, the approach of the signal ST carrying 3D content data is applied to a frame packaging and field alternative 3D data format. According to the approach of carrying 3D content data, different content data C1 and C2 in the multiplexing mode are also integrated to the signal ST. As shown in FIG. 5, as for the content data C1 in the multiplexing mode, data C1o(i) and Cle(i) of the content data C1 respectively corresponds to an odd field and an even field of a same frame. Likewise, data C2o(i) and C2e(i) of the content data C2 respectively corresponds to an odd field and an even field of a same frame. The data C1o(i) and C1e(i) of the content data C1 are respectively recorded in scan lines s(k1) to s(k1+Mo−1) and s(k3) to s(k3+Me−1), identical to the data C0_Lo(i) and C0_Le(i) of the 3D content data C0. Likewise, the data C2o(i) and C2e(i) of the content data C2 are respectively recorded in scan lines s(k2) to s(k2+Mo−1) and s(k4) to s(k4+Me−1), identical to the data C0_Ro(i) and C0_Re(i) of the 3D content data C0.

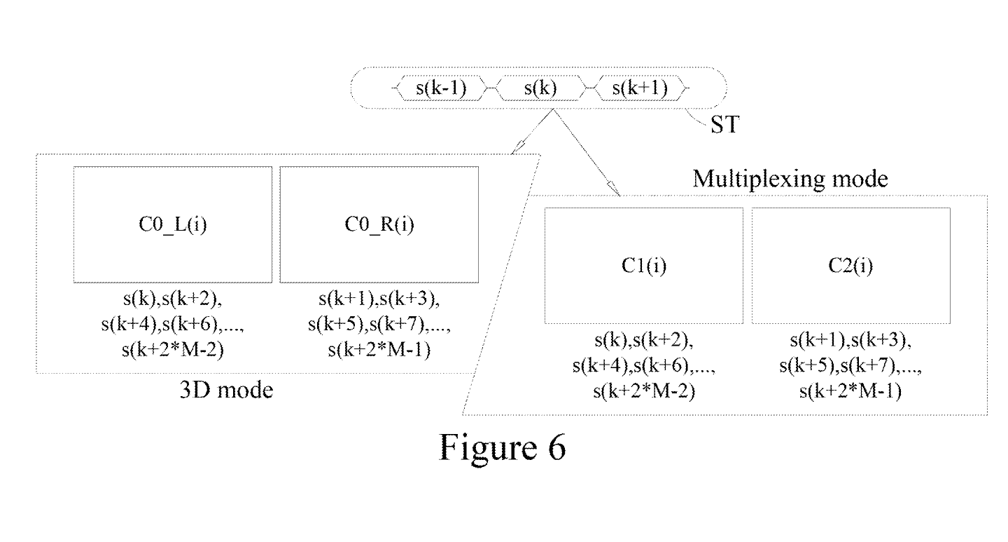

FIG. 6 is a schematic diagram of integration of different content data according to another embodiment of the present disclosure. In this embodiment, the 3D data C0 in the 3D mode is recorded in the signal ST in a line alternative form. The data C0_L(i) corresponding to a left frame of a 3D image is recorded in the scan lines s(k), s(k+2), s(k+4), s(k+6), . . . , s(k+2*M−2) with an interval of one scan line, and the data C0_R(i) corresponding to the right frame is recorded in interlacing scan lines s(k+1), s(k+3), s(k+5), s(k+7), . . . , to s(k+2*M−1). In the multiplexing mode, the data C1(i) of the content data C1 corresponding to a frame is recorded in scan lines s(k), s(k+2), s(k+4), s(k+6), . . . , s(k+2*M−2), and the data C2(i) of the content data C2 corresponding to a frame is recorded in interlacing scan lines s(k+1), s(k+3), s(k+5), s(k+7), . . . , to s(k+2*M−1), identical to the data C0_L(i) and C0_R(i) of the 3D content data C0. In this embodiment, the scan lines s(k) to s(k+2*M−1) can be arranged to be corresponding to a single vertical synchronous signal cycle.

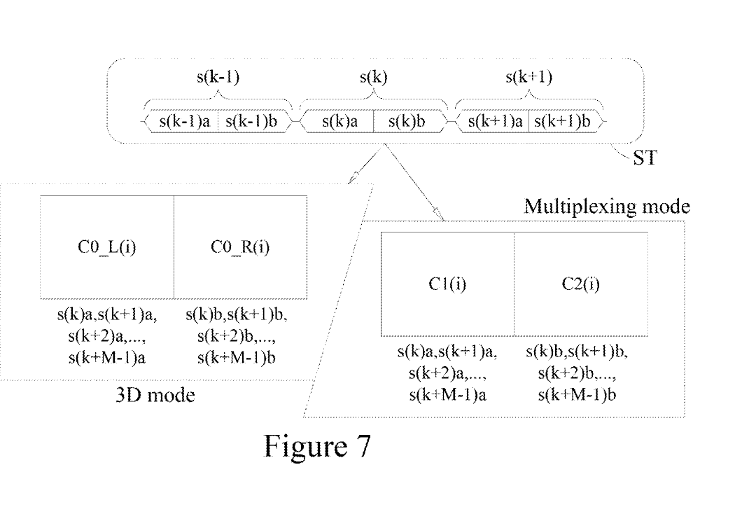

FIG. 7 is a schematic diagram of integration of different content data according to still another embodiment of the present disclosure. In this embodiment, the 3D data C0 in the 3D mode is recorded in the signal ST in a side by side mode. The scan lines of the signal ST are divided into two parts, former and latter, each corresponding to a plurality of pixels. For example, the scan line s(k) is divided into scan line segments s(k)a and s(k)b, the scan line s(k+1) is divided into scan line segments s(k+1)a and s(k+1)b, and the like. In the 3D mode, the data C0_L(i) corresponding to the left frame of a 3D image is recorded in the scan line segments s(k)a, s(k+1)a, s(k+2)a to s(k+M−1)a, and the data C0_R(i) corresponding to the right frame of the same 3D image is recorded in the scan line segments s(k)b, s(k+1)b, s(k+2)b to s(k+M−1)b. In the multiplexing mode, the data C1(i) of the content data C1 corresponding to a frame is recorded in the scan line segments s(k)a, s(k+1)a, s(k+2)a to s(k+M−1)a, and the data C2(i) of the content data C2 corresponding to a frame is recorded in the scan line segments s(k)b, s(k+1)b, s(k+2)b to s(k+M−1)b. In this embodiment, the scan lines s(k) to s(k+M−1) correspond to one vertical synchronous signal cycle.

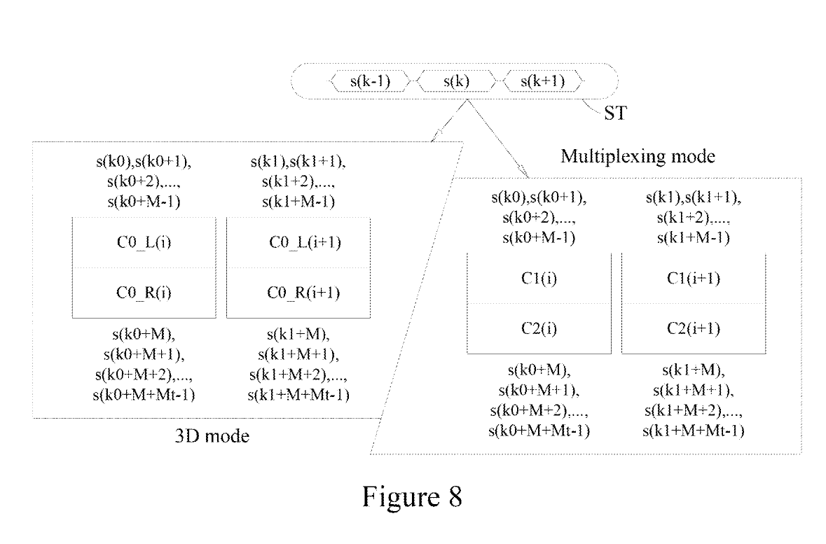

FIG. 8 is a schematic diagram of integration of different content data according to an embodiment of the present disclosure. In this embodiment, the 3D data C0 in the 3D mode is recorded in the signal ST in a top and bottom form. As to a single 3D image, the data C0_L(i) and C0_R(i) respectively corresponding to the left frame and the right frame of the 3D image are respectively recorded in the scan lines s(k0), s(k0+1), s(k0+2) to s(k0+M−1), and the subsequent scan lines s(k0+M), s(k0+M+1), s(k0+M+2) to s(k0+M+Mt−1). Likewise, for the next 3D image, the data C0_L(i+1) and C0_R(i+1) corresponding to the left frame and the right frame of the next 3D image are respectively recorded in the scan lines s(k1) to s(k1+M−1), and the subsequent scan lines s(k1+M) to s(k1+M+Mt−1), wherein k1 is larger than or equal to (k0+M+Mt−1). In the multiplexing mode, the data C1(i) and C1(i+1) of the content data C1 corresponding to two adjacent frames are identical to the data C0_L(i) and C0_L(i+1), such that the data C1(i) and C1(i+1) are respectively recorded in the scan lines s(k0) to s(k0+M−1) and the scan lines s(k1) to s(k1+M−1). Likewise, the data C2(i) and C2(i+1) of the content data C2 corresponding to two adjacent frames can be deduced to be identical to the data C0_R(i) and C0_R(i+1), and are respectively recorded in the scan lines s(k0+M) to s(k0+M+Mt−1) and the scan lines s(k1+M) to s(k1+M+Mt−1). In this embodiment, the scan lines s(k0) to s(k0+M+Mt−1) can be arranged to be corresponding to one vertical synchronous signal cycle, and the scan lines s(k1) to s(k0+M+Mt−1) correspond to the next vertical synchronous signal cycle.

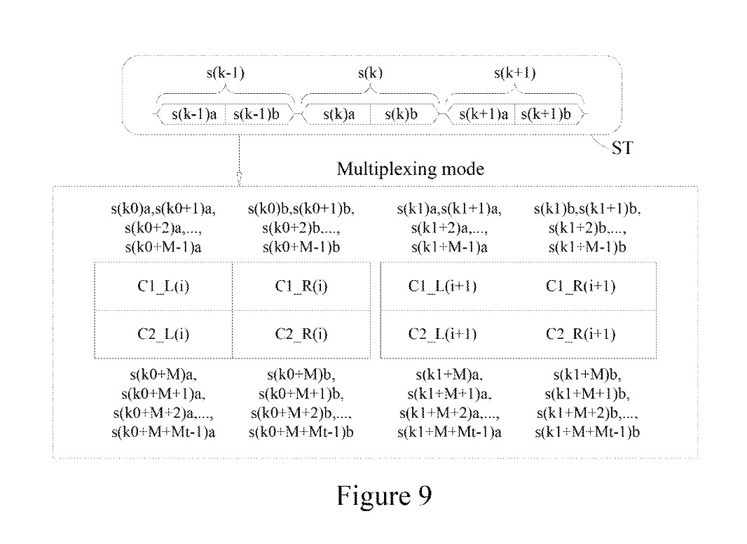

As discussed in FIG. 3, according to the multiplexing service of the present disclosure, different users can be provided with different 3D content data C1 and C2. Combining the techniques shown in FIG. 7 and FIG. 8, different 3D content data in the multiplexing mode can be integrated to the signal ST according to the present disclosure. FIG. 9 is a schematic diagram of integration of different content data according to an embodiment of the present disclosure. As shown in FIG. 9, as for the 3D content data C1, the data C1_L(i) and C1_R(i) respectively corresponds to a left frame and a right frame to integrate the 3D content data C1 to a 3D image data, and the data C1_L(i+1) and C1_R(i+1) respectively corresponds to a left frame and a right frame of the next 3D image. Likewise, as for the 3D content data C2, the data C2_L(i) and C2_R(i) respectively corresponds to a left frame and a right frame of a 3D image, and the data C2_L(i+1) and the C2_R(i+1) respectively corresponds to a left frame and a right frame of the next 3D image.

Similar to the embodiment shown in FIG. 7, the scan lines are divided into two parts, former and latter in FIG. 9. The data C1_L(i) is recorded in the scan line segments s(k0)a, s(k0+1)a, s(k0+2)a to s(k0+M−1)a, and the data C1_R(i) is recorded in the latter half parts, i.e., scan line segments s(k0)b, s(k0+1)b, s(k0+2)b to s(k0+M−1)b. The data C2_L(i) and C2_R(i) of the content data C2 are respectively recorded in the former half part and the latter half part, i.e., scan line segments s(k0+M)a, s(k0+M+1)a, s(k0+M+2)a to s(k0+M+Mt−1)a, and scan line segments s(k0+M)b, s(k0+M+1)b, s(k0+M+2)b to s(k0+M+Mt−1)b. Likewise, data C1_L(i+1), C2_R(i+1), C2_L(i+1) and C2_R(i+1) of the 3D content data C1 and C2 for forming the next 3D image are respectively recorded in scan line segments s(k1)a to s(k1+M−1)a, s(k1)b to s(k1+M−1)b, s(k1+M)a to s(k1+M+Mt−1)a, and s(k1+M)b to s(k1+M+Mt−1)b, wherein k1 is larger than (k0+M+Mt−1). In this embodiment, the scan lines s(k0) to s(k0+M+Mt−1) correspond to one vertical synchronous signal cycle, and the scan lines s(k1) to s(k1+M+Mt−1) correspond to the next vertical synchronous signal cycle.

In the embodiments of FIG. 4 to FIG. 9, when the data C1(i) and C2(i) (even the data C1_L(i), C1_R(i), C2_L(i) and C2_R(i)) corresponding to frames are recorded via the pixel data of the scan lines/scan line segments, the number of overall pixel data of the scan lines/scan line segments need not be equal to that of pixels of full screen. For example, the screen 24 in FIG. 2 may have a resolution of 1960*1080, i.e., an intra frame having 1960 pixels in a horizontal direction, and 1080 pixels in a vertical direction. When the multiplexing mode is implemented with the embodiment shown in FIG. 7, each of the scan line segments may include only 980 pixel data, and the data C1(i) and C2(i) are respectively recorded in 1080 scan line segments (i.e., M in FIG. 7 is equal to 1080). When the monitor 22 displays the frames corresponding to the data C1(i) (or C2(i)) in the full screen mode, the image processing circuit 26 performs appropriate interpolation and/or scaling processing (e.g., horizontal scaling processing) to display the full screen resolution of 1960*1080 according to 980 pixel data in 1080 scan line segments.

Likewise, in the embodiment of FIG. 8, the data C1(i) and C2(i) are respectively recorded in 540 scan lines (i.e., M=Mt=540), and each of the scan lines contains 1960 pixel data. Therefore, when the frames corresponding to the data C1(i) and C2(i) are to be displayed, the image processing circuit performs scaling processing (e.g., vertical scaling processing) to display the frames corresponding to the data C1(i) and C2(i) with the full screen resolution of 1960*1080. In the embodiment of FIG. 9, the data C1_L(i), C1_R(i), C2_L(i) and C2_R(i) are respectively recorded in the 540 scan line segments, each having 980 pixel data. When the full screen multiplexing playing is performed, the scaling processing (e.g., horizontal and vertical scaling) of the image processing circuit 26 may facilitate display of the data C1_L(i), C1_R(i), C2_L(i) and C2_R(i) in the full screen mode.

In the embodiments shown in FIG. 4 to FIG. 9, different content data in the multiplexing mode are integrated according to a 3D content data format for recording 3D content data in the 3D mode, such that the integration result is compatible to the 3D content data format in the 3D mode. In another embodiment, a novel format can be defined to carry a 3D content data in the 3D mode and different content data (e.g., 2D content data or 3D content data) in the multiplexing mode in a single stream. For example, the 3D content data in the 3D mode or the content data in the multiplexing mode corresponding to each data in the stream can be indicated according to the number of the horizontal pixel data and/or that of the scan lines. The mode detector 34 in FIG. 2 automatically switches the image playback system 20 between the 3D mode and the multiplexing mode according to instructions of the stream. Alternatively, whether the data is in the 3D mode or the multiplexing mode can be distinguished according to a position of a horizontal synchronous signal. Otherwise, the image playback system 20 can be indicated to play content data provided by the signal sources in either the 3D mode or the multiplexing mode according to types of signal sources.

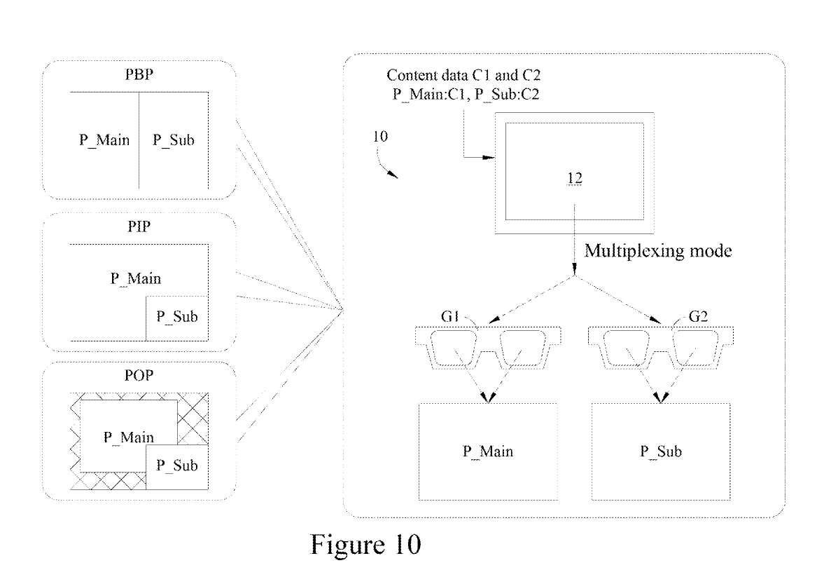

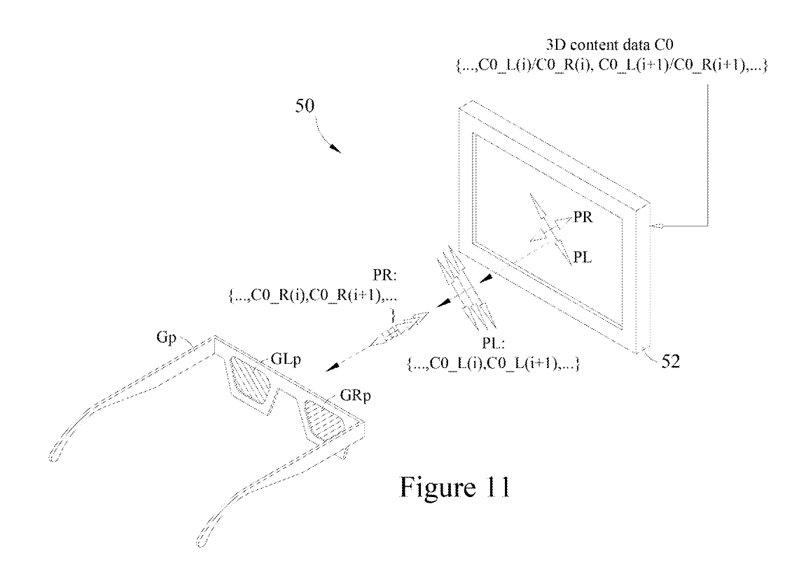

Furthermore, the multiplexing technique disclosed in the present disclosure can also be utilized for improving/replacing PBP, PIP and POP techniques in conventional TVs, as shown in FIG. 10. The PBP, PIP and POP techniques are utilized for displaying two different content data separately on frames P_Main and P_Sub. However, since the frames P_Main and P_Sub both occupy a display area of a screen, both of them cannot be displayed in the full screen mode, and the two frames do not interfere with each other. In comparison, as mentioned in the description of FIG. 1, the monitor 12 of the image playback system 10 respectively regard the content data of the frames P_Main and P_Sub as the content data C1 and C2 in the multiplexing mode, so as to respectively provide the frames P_Main and P_Sub to the users of the glasses G1 and G2 with the monitor 12 and the glasses G1 and G2. According to the present disclosure, different users may respectively view the frames P_Main and P_Sub in the full screen mode without interference by each other. In the embodiment shown in FIG. 2, the content data of the frame P_Main and P_Sub are directly transmitted to the image processing circuit 26, and the frames P_Main and P_Sub are scaled up to the full screen size for multiplexing playing. Content data M and S in FIG. 2 are respectively corresponding to the frames P_Main and P_Sub.

FIG. 11 is a schematic diagram of an image playback system 50 according to an embodiment of the present disclosure. A monitor 52 of the image playback system 50, together with a glasses Gp, play 3D content data C0 via polarized lights. Data C0_L(i) and C0_R(i) of the 3D content data C0 respectively corresponding to a left frame and a right frame form a 3D image, data C0_L(i) and C0_R(i) respectively corresponding to a left frame and a right frame of the next 3D image, and the like. When the image playback system 50 plays the 3D content data C0, the monitor 52 displays the left frame corresponding to the data C0_L(i) and C0_L(i+1) with a predetermined polarization PL (e.g., 45-degree linear polarization), and displays a right frame corresponding to the data C0_R(i) and C0_R(i+1) with a polarization PR (e.g., 135-degree linear polarization). In other words, the monitor 52 outputs an intra frame carrying both the left frame and the right frame, and simultaneously performs a left display and a right display to synchronously display the left frame and the right frame. For example, odd pixels of the monitor 52 correspond to a left frame of a left eye, and even pixels of the monitor 52 correspond to a right frame of a right eye. Alternatively, odd scan lines of the monitor 52 display the left frame, and even scan lines display the right frame. The monitor 52 may also combines the foregoing two approaches. Otherwise, for example, the monitor 52 may cooperate with an apparatus capable of positively converting polarization on a panel, for sequentially interleaving displaying the left frame and the right frame with different polarizations, similar to the monitor 22 in FIG. 2.

In order to cooperate with polarizations of frames allocated by the monitor 52, a left lens GLp of the glasses Gp allows lights polarized by the polarization PL to be transmitted through, and filters out lights polarized by the polarization PR. Therefore, only the left frames corresponding to the data C0_L(i) and C0_L(i+1) are capable of being transmitted through the left lens GLp, and the right frames corresponding to the data C0_R(i) and C0_R(i+1) is sheltered by the left lens GLp. Symmetrically, a right lens GRp only allows the lights polarized by the polarization PR to be transmitted through, and filters out the lights polarized by the polarization PL, such that the left frame corresponding to the C0_L(i) and C0_L(i+1) is sheltered by the right lens GRp, and only the right frame corresponding to the C0_R(i) and C0_R(i+1) can be transmitted through the right lens GRp. According to the left frame transmitted through the left lens GLp and the right frame transmitted through the right lens GRp, a user wearing the glasses Gp can view the 3D image.

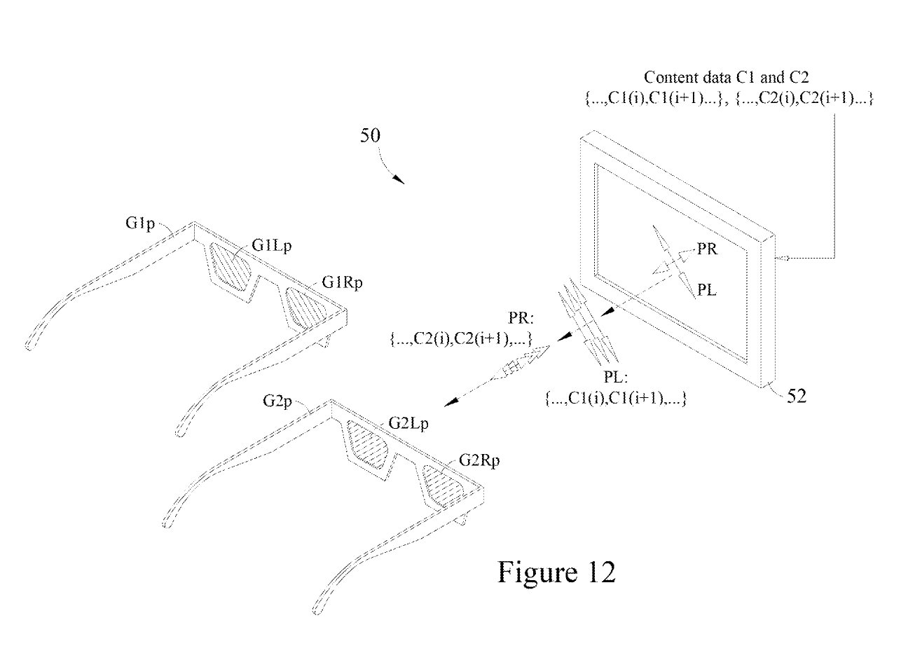

The multiplexing service provided by the present disclosure can also be implemented in the image playback system 50 in FIG. 11. FIG. 12 shows a schematic diagram of the image playback system 50 providing the multiplexing service according to an embodiment of the present disclosure. In the embodiment of FIG. 12, different content data C1 and C2 are multiplexing provided with two different glasses G1p and G2p. Pixels and/or scan lines forming two adjacent frames of the content data C1 are respectively represented by data C1(i) and C1(i+1), and data C2(i) and C2(i+1) carry two frames of the content data C2. When the image playback system 50 operates in the multiplexing mode for providing the multiplexing service, the monitor 52 displays the frames corresponding to the data C1(i) and C1(i+1) of the content data C1 with the polarization PL, and displays the data C2(i) and C2(i+1) of the content data C2 with the polarization PR. A left lens G1Lp and a right lens G1Rp of the glasses G1p only allow lights polarized by the polarization PL to be transmitted through, such that a user wearing the glasses G1p can view the content data C1 without interference by the content data C2. On the contrary, a left lens G2Lp and a right lens G2Rp of the glasses G2p only allow lights polarized by the polarization PR to be transmitted through, such that a user wearing the glasses G2p can view the content data C2 without interference by the content data C1.

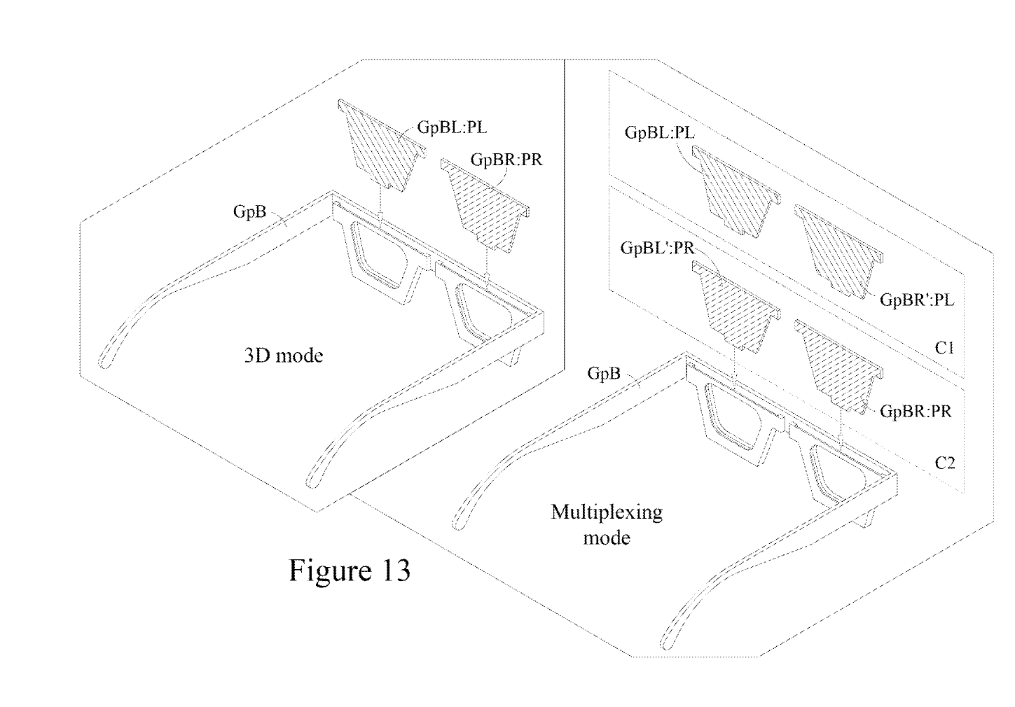

As an extension of the embodiments shown in FIG. 11 and FIG. 12, FIG. 13 shows an image playback system providing the 3D mode and the multiplexing mode according to another embodiment of the present disclosure. In the embodiment of FIG. 13, a pair of glasses GpB having interchangeable lenses is employed for implementations of the 3D mode and the multiplexing mode, which can be a polarization glasses, for example. A left lens of the glasses GpB can be mounted with either a left lens GpBL or GpBL′. The left lens GpBL only allows lights polarized by the polarization PL to be transmitted through, and the left lens GpBL' only allows lights polarized by the polarization PR to be transmitted through. Likewise, a right lens GpBR or GpBR′ can be interchangeably mounted on the right lens part of the glasses GpB. The right lens GpBR only allows lights polarized by the polarization PR to be transmitted through, and the right lens GpBR' only allows lights polarized by the polarization PL to be transmitted through.

When viewing the 3D content data C0 in the 3D mode in FIG. 11, the user may assemble the glasses GpB with the left lens GpBL and the right lens GpBR. When the monitor 52 multiplexingly plays the content data C1 and C2 with the polarizations PL and PR as shown in FIG. 12, a user viewing the content data C1 assembles the glasses GpB with the left lens GpBL and the right lens GpBR′ to view the content data C1 without interference since the two lenses GpBL and GpBR′ only allow lights polarized by the polarization PL to be transmitted through. Meanwhile, a user viewing the content data C2 assembles the glasses GpB with the left lens GpBL' and the right lens GpBR to view the content data C2 polarized by the polarization PR.

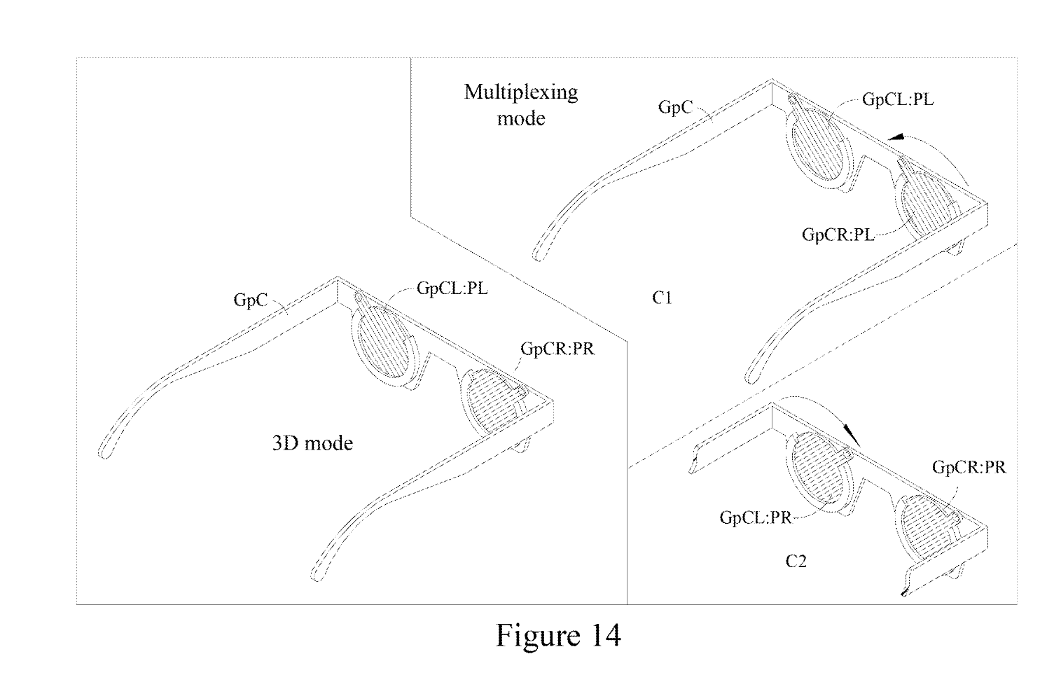

FIG. 14 is a schematic diagram of the monitor 52 providing the multiplexing service according to an embodiment of the present disclosure, which is an extension of embodiments shown in FIG. 11 and FIG. 12. In this embodiment, a rotatable glasses GpC is employed to implement the 3D mode and the multiplexing mode. In the 3D mode, a user of the glasses GpC rotates a left lens GpCL and a right lens GpCR, such that the left lens GpCL filters out lights polarized by the polarization PR and only allows lights polarized by the polarization PL to be transmitted through, and the right lens GpCR filters out lights polarized by the polarization PL and only allows lights polarized by the polarization PR to be transmitted through. Accordingly, the user can view the 3D content data C0.

When the monitor 52 provides the multiplexing service and respectively plays the content data C1 and C2 with the polarizations PL and PR, the right lens GpCR in the 3D mode is rotated by 90 degrees to filter out lights polarized by the polarization PR, and only allows lights polarized by the polarization PL to be transmitted through, such that the user can view the content data C1. Meanwhile, the left lens GpCL in the 3D mode is rotated by 90 degrees to filter out lights polarized by the polarization PL, and only allows lights polarized by the polarization PR to be transmitted through, such that the user can view the content data C2.

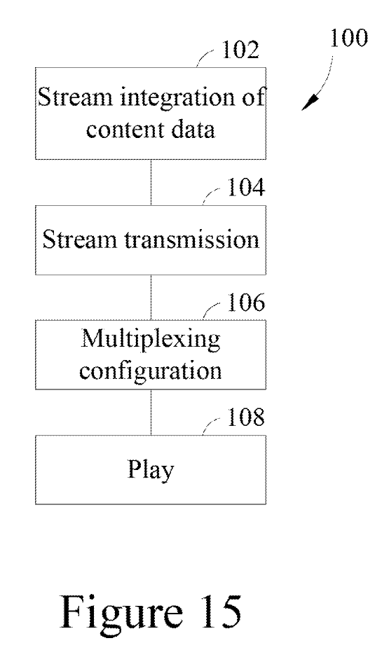

FIG. 15 is a flowchart of a flow 100 for providing a multiplexing display service according to an embodiment of the present disclosure. Steps of the flow 100 can be described as follows. In Step 102, since a stream can be easily stored, recorded and transmitted, a plurality of content data are integrated to a single stream in the present disclosure. Each of the content data comprises a plurality of pixels, and the stream comprises a plurality of intra frames respectively related to a plurality of frames of a plurality of content data. For example, each intra frame is related to a frame of content data as discussed in the description of FIG. 4. Alternatively, each intra frame is related to frames of different content data. For example, in the multiplexing mode in FIG. 5, an intra frame is corresponding to odd fields or even fields of frames of different content data, e.g., data C1o(i) ,C2o(i), Cle(i) and C2e(i) (respectively corresponding to an odd field of the content data C1, an odd field of the content data C2, an even field of the content data C1 and an even filed of the content data C2) are integrated into two frames. In the multiplexing mode as discussed in the descriptions of FIG. 6, frames of different content data are respectively carried by even scan lines and odd scan lines of a same frame. In the embodiments of the multiplexing modes in FIG. 7 and FIG. 9, a same intra frame carries frames of different content data. In Step 104, the integrated stream is transmitted to the image playback system. In Step 106, necessary multiplexing configurations and definitions are performed. For example, in the image playback system cooperating with shutter glasses, each of the shutter glasses is correlated to a corresponding identification code. Alternatively, each of the shutter glasses is set to shelter other unnecessary content data. In the image playback system employing polarization, different glasses are adopted according to different content data as mentioned in the embodiments of FIG. 12, FIG. 13 or FIG. 14. In Step 108, a monitor in the image playback system plays intra frames of the stream, cooperating with glasses to provide the multiplexing service. For example, in the image playback system cooperating with shutter glasses, the monitor interleaving displays a first frame of first content and a second frame of second content. The shutter glasses for viewing the first content has a left lens and a right lens that synchronously shelters the second frame when the second frame is displayed. In the image playback system employing polarization, the monitor simultaneously plays the first frame and the second frame with lights polarized by first polarization and second polarization, and a passive pair of glasses for viewing the first content shelters lights polarized by the second polarization.

In conclusion, different content data are multiplexed and provided by deploying a 3D content data capability of a 3D image playback system to playing all of the content data in a full screen mode without interference by each other. For example, family or group members can view different content data with a single monitor, and cooperate and/or compete with each other in electronic games or applications of education training with the same monitor. With the present disclosure, Chinese traditional mahjong games can be very entertaining, i.e., each of four persons views his mahjong tiles completely displayed in a full screen mode of a single monitor without worrying about others seeing his mahjong tiles. In tennis doubles game provided by the electronic game Wii, both competitors can completely view their own court in a full screen mode of a single monitor, thereby having more fun.

While the present disclosure has been described in terms of what is presently considered to be the most practical and preferred embodiments, it is to be understood that the present disclosure need not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. An image playback system, comprising:
a monitor, operating in either of a three-dimension (3D) mode and a multiplexing mode, that displays a left frame and a right frame of a 3D content data in the 3D mode, and that displays a first frame of a first content data and a second frame of a second content data in the multiplexing mode; and
a pair of first glasses and a pair of second glasses, each respectively having a left lens and a right lens, the left lens and the right lens of the first glasses sheltering the second frame displayed on the monitor, the second frame displayed on the monitor being transmitted through the left lens and the right lens of the second glasses.

2. The image playback system of claim 1, wherein when the monitor operates in the multiplexing mode, the first frame displayed on the monitor is transmitted through the left lens and the right lens of the first glasses.

3. The image playback system of claim 1, wherein when the monitor operates in the 3D mode, the left frame displayed on the monitor is transmitted through the left lens of the first glasses and the left lens of the second glasses, and wherein the right frame displayed on the monitor is transmitted through the right lens of the first glasses and the right lens of the second glasses.

4. The image playback system of claim 1, wherein the monitor displays the first frame and the second frame in an interleaving fashion, wherein the first glasses comprise shutter glasses, and wherein the left lens and the right lens of the shutter glasses synchronously shelter the second frame displayed on the monitor.

5. The image playback system of claim 1, wherein the monitor displays the first frame with a first polarization and the second frame with a second polarization different from the first polarization, and wherein the left lens and the right lens of the first glasses shelter lights polarized by the second polarization.

6. The image playback system of claim 1, wherein the monitor displays the left frame and the right frame in an interleaving fashion, and wherein the first glasses and the second glasses are shutter glasses.

7. The image playback system of claim 1, wherein the monitor simultaneously displays the left frame and the right frame, and wherein the first glasses and the second glasses are polarization glasses.

8. The image playback system of claim 1, wherein the first glasses have a first identification code, and wherein the second glasses have a second identification code.

9. The image playback system of claim 8, wherein the monitor allocates a first identification code and a second identification code to the first glasses and the second glasses, respectively, via a predetermined procedure.

10. The image playback system of claim 1, wherein the first glasses and the second glasses respectively comprise a first switch and a second switch, and wherein the monitor broadcasts an identification code which is selectively recorded by the first glasses and the second glasses when one of the first switch and the second switch is selectively pressed.

11. The image playback system of claim 1, wherein the first glasses and the second glasses respectively comprise a first switch and a second switch, and wherein the first glasses obtain a first identification code and the second glasses obtain a second identification code by adjusting the first switch and the second switch.

12. A pair of glasses cooperating with a monitor, the monitor capable of displaying a left frame and a right frame of a three-dimension (3D) content data in a 3D mode and displaying a first frame of first content data and a second frame of second content data in a multiplexing mode, the glasses comprising:
a left lens that transmits through the left frame displayed on the monitor and shelters the right frame displayed on the monitor in the 3D mode, and that shelters the second frame displayed on the monitor in the multiplexing mode; and
a right lens that transmits through the right frame displayed on the monitor and shelters the left frame displayed on the monitor in the 3D mode, and that shelters the second frame displayed on the monitor in the multiplexing mode.

13. The glasses of claim 12, wherein the first frame is transmitted through the left lens and the right lens in the multiplexing mode.

14. The glasses of claim 12, wherein the monitor displays the left frame and the right frame in an interleaving fashion in the 3D mode and displays the first frame and the second frame in an interleaving fashion in the multiplexing mode, and wherein the left lens and the right lens synchronously shelter the second frame displayed on the monitor in the multiplexing mode.

15. The glasses of claim 12, wherein the monitor displays the left frame and the first frame with a first polarization and displays the right frame and the second frame with a second polarization different from the first polarization, and wherein the left lens and the right lens shelter lights polarized by the second polarization when the monitor operates in the multiplexing mode.

16. The glasses of claim 12, further comprising a switch that provides an identification code to the glasses.

17. An image playback system, comprising:
a monitor that displays a plurality of frames; and
a plurality of glasses, each having two lenses selectively transmitting a predetermined frame simultaneously when the monitor displays the predetermined frame among the frames.

18. The image playback system of claim 17, wherein the monitor displays the frames in sequence.

19. The image playback system of claim 17, wherein the monitor simultaneously displays the frames within a same intra frame.

20. The image playback system of claim 17, wherein the monitor respectively allocates a plurality of identification codes to the glasses via a predetermined procedure.

21. The image playback system of claim 17, wherein the lenses of each glasses selectively shelter the predetermined frame simultaneously when the monitor displays the predetermined frame among the frames.
